(19) United States
(12) Patent Application Publication
(10) Pub. No.: US 2009/0271635 A1
(43) Pub. Date: Oct. 29, 2009

(54) METHODS AND SYSTEMS FOR AUTHENTICATION

(75) Inventors: Hongwei Liu, Shenzhen (CN); Shuling Liu, Shenzhen (CN); Jiwei Wei, Shenzhen (CN); Bing Liu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/388,315

(22) Filed: Feb. 18, 2009

Related U.S. Application Data
(63) Continuation of application No. PCT/CN2007/070446, filed on Aug. 10, 2007.

(30) Foreign Application Priority Data
Aug. 18, 2006 (CN) 200610109879.9
Oct. 30, 2006 (CN) 200610136497.5
Oct. 30, 2006 (CN) 200610136498.X

(51) Int. Cl. G06F 21/00

(52) U.S. Cl. 713/186

(57) ABSTRACT

The present invention discloses a method and system for authentication. The method for authentication includes: acquiring the privilege security level corresponding to a client-end; inquiring the identity security level corresponding to the privilege security level according to an established relation of association between privilege security level and identity security level; determining the authentication parameters for identity authentication according to the identity security level; performing identity authentication on the client-end using the authentication parameters; and obtaining an authentication result. The identity authentication and privilege authentication are combined, and identity authentication is performed according to the identity security level in accord with the privilege security level so that rules of identity authentication can be adjusted, and the flexibility of the process of authentication may be improved.

This application claims priority to Chinese Patent Application No. 200610109879.9, entitled “Method, Unit and System for Authentication Through Combination of Identity and Privilege” and filed with the Chinese Patent Office on Aug. 18, 2006, Chinese Patent Application No. 200610136498.X, entitled “Method, and Device for Setting Template of Biometric Security Level” and filed with the Chinese Patent Office on Oct. 30, 2006, and Chinese Patent Application No. 200610136497.5, entitled “Method and System for Authentication” and filed with the Chinese Patent Office on Oct. 30, 2006, which are hereby incorporated by reference in their entireties.

### FIELD OF THE INVENTION

The present invention relates to information security technologies, and in particular to a method and system for authentication.

### BACKGROUND OF THE INVENTION

With the rapid development of Internet, electronic business has been gaining popularity in many fields, such as online banks and online transactions. The traditional way of protecting personal account information by password is obviously not enough to guarantee the security of data. In recent years, Internet fraud and theft of account have become more and more serious. Therefore, it is imperative to develop higher-level security mechanism of personal information protection and authentication.

The Pubic Key Infrastructure (PKI) has been applied in some fields. Public certificates which can be public and store public keys and other information of users are distributed to the users by the authority. The private key corresponding to the public key is kept by the users themselves. A public key has a unique relation of association with a private key, which cannot be deduced by the private key, and information encrypted by the public key can only be decrypted by the private key. Such characteristic of the PKI can have the authenticator confirm whether the user is the entity declared in the public key certificate by verifying the private key, and as a result it can assure that users' information of user would not be stolen illegally.

In the PKI mechanism, it is the key point to protect the private key of user. Private keys usually are deposited as digital information in some hardware. If a private key is lost, it means that the personal information of user may be exposed.

The technologies of biometric identification refer to the technologies that identity authentication is performing by using human physical futures or behavior futures, such as the identification technology of fingerprint, iris, etc. In recent years, biometric identification technologies are becoming more and more mature. Due to the special condition that identification is performed through Internet, identification combined with biometric features can take advantages of biometric features such as unique and stability, and provide guarantee for information security.

It is an effective way of protecting information that identity authentication is performed using personal biometric information. Taking account of the characteristics of biometric information, and the special condition that identity authentication is performed through Internet, it can form a more secure authentication architecture by combining biometric information with PKI.

The PKI system is a mechanism for personal identification, while biometric features are the fundamental elements for verifying personal identity, so it can take advantage of both PKI and biometric features, and overcome the fault of each of the two technologies. Taking the method for authentication by matching at the client-end as an example, the detailed process is shown in FIG. 1: the authenticator determines the validity of the user's identity by matching the collected biometric feature sample of the user with the biometric feature template in the biometric certificate provided by the user.

According to the various requests for different users, the service provider is able to grant different privileges to different users, using Privilege Management Infrastructure (PMI).

PMI is a combination of attribute certificate, attribute privilege, attribute certificate repository and so on, and implements any of, but not limit to, the following functions: privilege and certificate generating, management, storage, distribution and withdrawing.

An attribute certificate (AC) defines a privilege for an entity. The combination of the entity and privilege is provided by a data structure with digital signature. Such data structure signed and managed by attribute authority is called attribute certificate. The AC includes an expanding mechanism and a series of special certificate expanding mechanism. As shown in FIG. 2, the format of the attribute certificate includes any of the following ones: version, series number, period of validity, issuer, signature algorithm and the identifier thereof, holder, unique information of issuer, attribute information, extension information and signature of issuer.

PMI provides a new infrastructure for protecting information, which is closely integrated with the PKI and catalog service, and establishes a mechanism for granting particular privilege to certificated users systematically. PMI provides a systematical definition and description for the privilege management, and thus provides whole processes needed during authorization service.

Identity authentication and privilege authentication are of vital importance for data security. In prior art, there is a method for identity and privilege authentication through performing identity and privilege authentication separately, including the following steps:

when performing privilege authentication, a sever receives a request for authorization from a user;

the sever performs authentication according to preset authentication rules; and

if the authentication is passed, the sever grants the corresponding privilege to the user.

The process of performing identity authentication is similar to the process of privilege authentication, during which authentication is perform by the server according to some preset authentication rules, and the two types of authentication are performed independently. However, only to perform identity authentication or only to carry out privilege authentication cannot guarantee accuracy of the authentication.

Another method for identity and privilege authentication in prior art includes:

performing identity authentication firstly; and

performing privilege authentication, when identity authentication is passed.

Such technical scheme may improve strictness of the whole authentication process, and also accuracy. However, such process is performed only according to some preset rules so that the authentication rules cannot be adjusted in accordance with practical situations, and cannot perform authentication dynamically, as a result, the flexibility of the process of identity and privilege authentication is limited.

### SUMMARY OF THE INVENTION

Methods and systems for implementing authentication are provided in the embodiments of the present invention.

An embodiment of the present invention provides a method for authentication through combination of identity and privilege, including:

acquiring the privilege security level corresponding to a client-end;

inquiring the identity security level corresponding to the privilege security level according to an established relation of association between privilege security level and identity security level;

determining the authentication parameters for identity authentication according to the identity security level;

performing identity authentication on the client-end using the authentication parameters; and

obtaining an authentication result.

Another embodiment of the present invention provides a system for authentication through. combination of identity and privilege, including: an extracting unit, a biometric processing unit and an authenticating unit, wherein:

the extracting unit is configured to acquire the privilege security level corresponding to a client-end, and send the privilege security level to the biometric processing unit;

the biometric processing unit is configured to inquire the identity security level corresponding to the privilege security level according to an established relation of association between privilege security level and identity security level, determine the authentication parameters for identity authentication according to the identity security level, and send the authentication parameters to the authenticating unit; and

the authenticating unit is configured to perform identity authentication on the client-end using the authentication parameters.

Another embodiment of the present invention provides a method for biometric authentication, including:

acquiring a unique identifier for parameter information;

inquiring the biometric authentication parameters corresponding to the unique identifier for parameter information according to an established list of biometric security level;

receiving biometric information of a user from a client-end; and

performing biometric authentication on the biometric information of the user from the client-end according to the biometric authentication parameters.

Another embodiment of the present invention provides a system for biometric authentication, including an authentication-end, wherein

the authentication-end is configured to acquire, from a client-end, a unique identifier for parameter information and biometric information of the user, inquire the biometric authentication parameters corresponding to the unique identifier for parameter information according to an established list of biometric security level, and perform biometric authentication on the biometric information of user from the client-end according to the biometric authentication parameters.

It can be seen from the foregoing technical schemes that, there are several advantages related to embodiments of the present invention, including the following:

First, the identity authentication and privilege authentication are combined, and identity authentication is performed according to the identity security level in accord with the privilege security level required for access; therefore, rules of identity authentication can be adjusted according to practical situations, and the flexibility of the process of authentication can be improved.

Second, an alive-being biometric template and a biometric template of user are matched according to certain matching algorithm, a matching score is obtained, and it is determined whether the authentication is passed or not by comparing the matching score with a threshold; therefore, accuracy of the authentication is improved.

### BRIEF DESCRIPTION OF THE DRAWINGS

FIG. 1 is a flow chart of the process for performing identity authentication using biometric template in the prior art;

FIG. 2 shows the format of an attribute certificate;

FIG. 3 shows the format of biometric extension information in the an attribute certificate;

FIG. 4 is a flow chart of a method according to an embodiment of the present invention;

FIG. 5 is another flow chart of a method according to an embodiment of the present invention;

FIG. 6 is a structure diagram of a system according to an embodiment of the present invention;

FIG. 7 is a diagram showing functions of a system according to an embodiment of the present invention;

FIG. 8 is a structure diagram of a biometric processing unit according to an embodiment of the present invention;

FIG. 9 is a diagram showing function of a biometric-processing unit according to an embodiment of the present invention;

FIG. 10(a)˜(c) show formats of templates of biometric security level according to embodiments of the present invention;

FIG. 11 is a flow chart of a process of setting template of biometric security level according to an embodiment of the present invention;

FIG. 12 is a structure diagram of a device for setting template of biometric security level according to an embodiment of the present invention;

FIG. 13 is a flow chart of a process for biometric authentication in an embodiment of the present invention;

FIG. 14 is a flow chart of a process according to a more detailed embodiment compared to the process shown in the FIG. 13; and

FIG. 15 is a structure diagram of a biometric authentication system for performing the process shown in the FIG. 13.

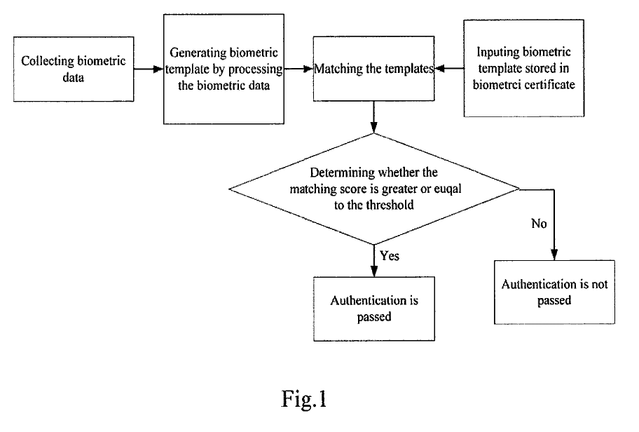

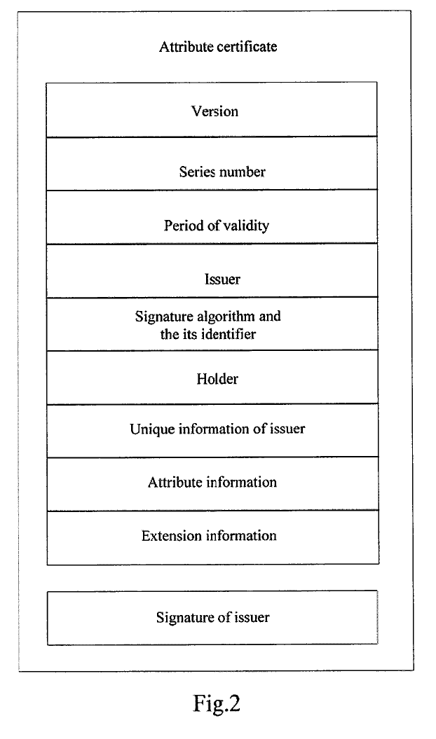

### DETAILED DESCRIPTION OF THE EMBODIMENTS

In embodiments of the present invention providing methods and systems for authentication, the rules for authentication can be adjusted according to practical situations, and the flexibility of the process for authentication can be improved.

In order to make use of biometric authentication, the PMI system should be supplemented slightly. In order to minimize the influence on the system, an extension item is added to the attribute certificate.

The extension information of the attribute certificate is mainly for declaring policies related to application of the certificate. The extension information of the attribute certificate includes the following:

basic extension information, privilege revoking extension information, root attribute authority extension information, role extension information and grant extension information, etc.

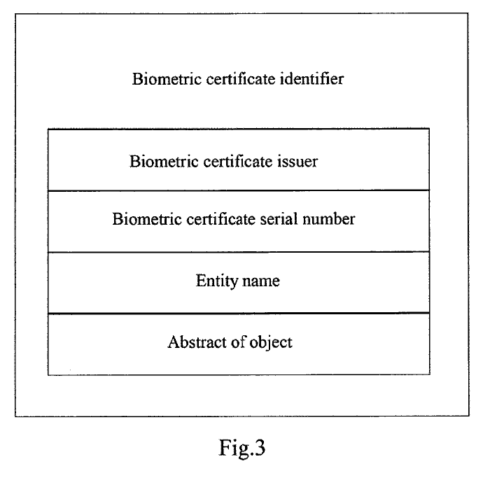

When performing privilege authentication using attribute certificate, authentication on the client's identity is performed first. Attribute certificate and biometric certificate are combined, so as to assure accuracy of relation of association between privilege and identity. Therefore, index information related to biometric certificate is added into biometric extension information of the attribute certificate, with the renewed biometric extension within the basic extension information. The biometric extension is called biometric certificate identifier, which is illustrated in FIG. 3.

As illustrated in FIG. 3, the biometric certificate identifier includes the following: “biometric certificate issuer and biometric certificate serial number”, entity name and abstract of object, wherein:

Biometric certificate issuer and biometric certificate serial number are marks of the biometric certificate corresponding to the holder of the attribute certificate, i.e., the biometric certificate needed for identity authentication on the holder of the attribute certificate. When performing identity authentication on the holder of the attribute certificate, colleted biometric data of the holder is matched with the template of the biometric certificate to obtain the result of authentication. The biometric certificate issuer and biometric certificate serial number may be both optional.

Entity name is mark of names of one or multiple attribute certificate holders. If it is the only item in the biometric extension, any biometric certificate corresponding to subject name included in the entity name may be used for authenticating identity of the holder of the attribute certificate. In other words, as long as the subject name of biometric certificate is included in the entity name, the subject name may be used for authenticating identity of the holder. Identity authentication may be passed if any biometric certificate of the holder passes authentication. However, if there are both the item of “biometric certificate issuer and biometric certificate sequence number” and the entity name, the item of “biometric certificate issuer and biometric certificate sequence number” is taken as the first choice to perform authentication.

Abstract of object is abstract information obtained through calculation based on parameters including serial number of the biometric certificate of the attribute holder, period of validity, subject and the unique identifier of the subject, issuer and the unique identifier of the issuer, identifier of template format, biometric feature template and extension information, is used for authenticating identity of the attribute certificate holder. When performing identity authentication on the holder, the abstract is obtained based on the biometric certificate of the holder. The abstract is then compared with the object abstract information in the biometric extension of the attribute certificate, if identical the biometric certificate in accord with the attribute certificate is the right one provided by the holder, and the further process of identity authentication is performed.

The biometric extension includes at least any item of the following: “biometric certificate issuer and biometric certificate serial number”, entity name and abstract of object, so as to assure that the biometric certificate can be looked up according to the associated attribute certificate.

If identity authentication is performed using PKI public key certificate including biometric template, the relation of association between attribute certificate and biometric template can be established through an index of attribute certificate to the PKI certificate. The index is not established through extension index, but through the definition by the holder of the attribute certificate.

Privileges of client-end and privilege security level are included in the attribute certificate. Biometric template of client-end is included in biometric certificate. Identity security level is included in biometric algorithm certificate, and for each level there are corresponding parameters of biometric template processing algorithm, matching algorithm parameters and threshold. Privilege security level in the attribute certificate and the identity security level in the biometric algorithm certificate are associated, and so are the value of privilege security level and the value of identity security level, and thus in this way privilege is associated with identity through the association between the two values.

When performing identity authentication, the system obtains privilege security level by extracting attribute certificate, and then determines parameters for use by matching privilege security level and identity security level extracted from biometric algorithm certificate, including parameters of biometric template processing algorithm, parameters of matching algorithm and threshold.

In an embodiment of the present invention, when an application unit receives an access request from a client-end, the application unit requests biometric certificate and attribute certificate from the client-end. Then the application unit authenticates the attribute certificate received and obtains privilege security level and access privilege from the attribute certificate. The application unit extracts the biometric algorithm certificate stored in the authentication-end and obtains identity security level. The application unit determines the parameters of biometric processing algorithm and threshold, and generates alive-being biometric template. The application unit extracts the biometric certificate of the client-end and obtains biometric template of user. The application unit matches the alive-being biometric template with the biometric template of user, and obtains a matching score. According to the threshold and the matching score, the application unit determines whether the authentication is passed or not. If the authentication is passed, the application unit returns response to the request from the client.

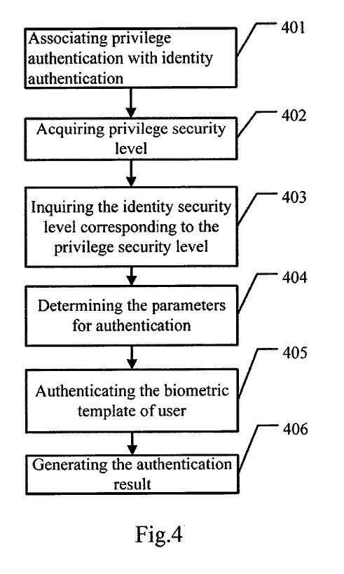

As illustrated in FIG. 4, the general process of an embodiment of the present invention includes the following steps:

401: Associating privilege authentication with identity authentication;

In this step, it may be a way of associating privilege authentication with identity that the privilege security level of the attribute certificate is associated with the identity security level of the biometric algorithm certificate;

402: Acquiring privilege security level;

403: Inquiring the identity security level corresponding to the privilege security level;

In this step, it may be a way of inquiring the identity security level corresponding to the privilege security level that the identity security level corresponding to the privilege security level is inquired according to the relation of association between the privilege security level and the identity security level.

404: Determining the parameters for authentication;

In this step, it may be a way of determining the parameters for authentication that the parameters for authentication is determined according to the identity security level inquired. The parameters for authentication may include parameters of alive-being biometric template processing algorithm, parameters of matching algorithm and threshold.

405: Authenticating the biometric template of client using the parameters for authentication determined in step 404;

406: Generating the authentication result.

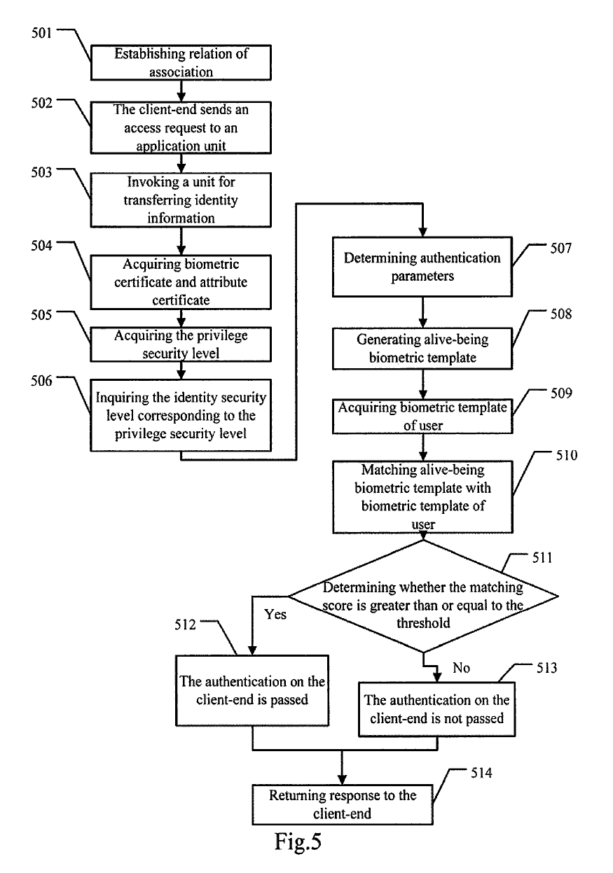

As illustrated in FIG. 5, the detailed process of an embodiment of the present invention includes the following:

501: Establishing relation of association between privilege security level and identity security level;

In this step, the established relation information is stored in biometric algorithm certificate, and the relation information may also be stored in other location, such as a database, etc.

Besides this way of associating privilege authentication with identity authentication by establishing association between privilege security level and the privilege security level, there may be other ways of associating privilege authentication with identity authentication.

502: The client-end sends an access request to an application unit;

In this step, the request sent may be for applying for resources used for accessing the application unit.

503: Invoking a unit for transferring identity information;

In this step, the unit for transferring identity information is invoked to request biometric certificate and attribute certificate from the client-end.

504: Acquiring biometric certificate and attribute certificate;

In this step, after sending request for biometric certificate and attribute certificate to the client, the unit for transferring identity information receives biometric certificate and attribute certificate from the client-end.

505: Acquiring the privilege security level;

In this step, an extracting unit extracts the attribute certificate transferred by the unit for transferring identity information, to obtain the privilege security level.

506: Inquiring the identity security level corresponding to the privilege security level;

In this step, a biometric processing unit inquires the identity security level corresponding to the privilege security level according to the established relation of association between privilege security level and identity security level.

507: Determining authentication parameters;

In this step, the biometric processing unit determines authentication parameters according to the identity security level inquired, including: parameters of alive-being biometric template processing algorithm, matching algorithm parameters and threshold.

508: Generating alive-being biometric template;

In this step, the biometric processing unit generates alive-being biometric template according to the received biometric information of user and the parameters of alive-being biometric template processing algorithm.

509: Acquiring biometric template of user;

In this step, the biometric processing unit extracts biometric template of user from the biometric certificate obtained from the client-end. This step may be performed after or before acquiring biometric certificate of user.

510: Matching alive-being biometric template with biometric template of user;

In this step, an authenticating unit matches the alive-being biometric template with the biometric template of user, and obtains a matching score. There may be various ways of matching, which are not limited.

511: Determining whether the matching score is greater than or equal to the threshold, if the matching score is greater than or equal to the threshold, the process proceeds to step 512; otherwise the process proceeds to step 513;

In this step, the threshold may be one of the authentication parameters, which is obtained according to the identity security level.

512: If the authentication on the client-end is passed, the process proceeds to step 514;

513: If the authentication on the client-end is not passed, the process proceeds to step 514;

514: Returning response to the client-end.

In this step, the response including authentication result is returned to the client-end.

In an embodiment of the present invention, when the application unit receives an access request from the client-end, the application unit invokes the unit for transferring identity information. The unit for transferring identity information requests biometric certificate and attribute certificate from the client-end; the extracting unit extracts the attribute certificate to obtain privilege security level and access privilege;

The biometric processing unit invoked by the unit for transferring identity information extracts biometric algorithm certificate to obtain identity security level, and determines the biometric processing parameters and threshold according to the identity security level, and generates alive-being biometric template.

The biometric processing unit extracts the biometric certificate of the client-end to obtain biometric template of user, and matches the alive-being biometric template and the biometric template of user to get a matching score. The authenticating unit determines whether the identity authentication is passed according to the matching score and the threshold. If the identity authentication is passed, the unit for transferring identity information returns the privilege to the application unit. The application unit returns the resource requested to the client-end.

The privilege of client-end and the privilege security level are included in the attribute certificate. The biometric template of user is included in the biometric certificate on the client-end. The relation of association between privilege security level and identity security level is included in the biometric algorithm certificate. For each privilege security level or identity security level, there are corresponding parameters including alive-being biometric template processing algorithm parameters, matching algorithm parameters and threshold.

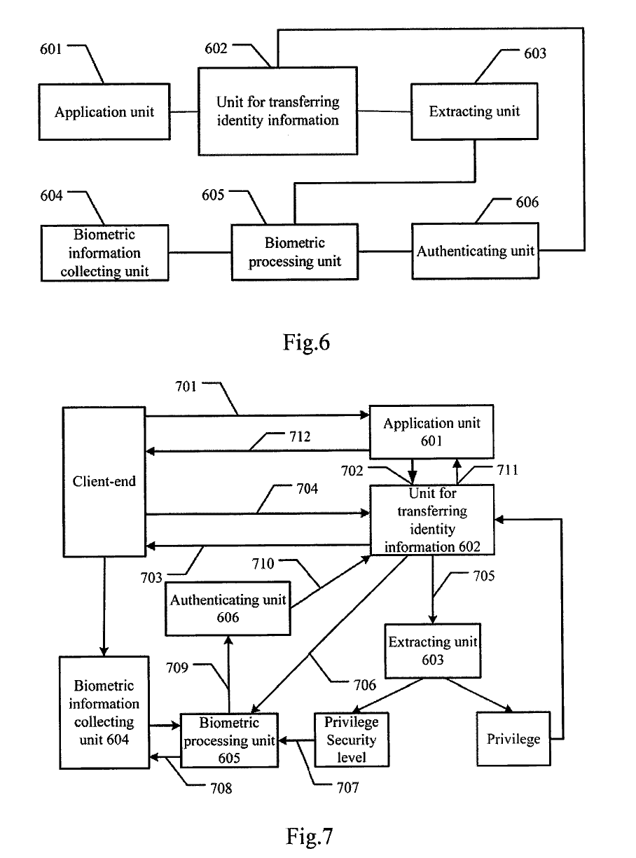

As illustrated in FIG. 6, a system according to an embodiment of the present invention includes: an application unit 601, a unit for transferring identity information 602, an extracting unit 603, a biometric information collecting unit 604, a biometric processing unit 605 and an authenticating unit 606.

In this embodiment, the client-end sends an access request to the application unit 601. The application unit 601 is configured to invoke the unit for transferring identity information 602 after receiving the access request. The unit for transferring identity information 602 is configured to send a request for attribute certificate and biometric certificate to the client-end. After receiving the attribute certificate and biometric certificate from the client-end, the unit for transferring identity information 602 sends the attribute certificate and biometric certificate to the extracting unit 603 and the biometric processing unit 605. The extracting unit 603 is configured to acquire privilege security level from the attribute certificate and send the privilege security level to the biometric processing unit 605.

The unit for collecting biometric information 604 is configure to acquire biometric information of user from the client-end and send the biometric information of user to the biometric processing unit 605.

Receiving the privilege security level, the biometric processing unit 605 is configured to inquire identity security level corresponding to the privilege security level according to the relation of association between the privilege security level and identity security level. The biometric processing unit 605 determines authentication parameters according to the identity security level, and generates alive-being biometric template in terms of biometric information of user from the unit for collecting biometric information 604, and sends the authenticating unit 606 the alive-being biometric template, biometric template of the client in the biometric certificate of the client, matching algorithm parameters and threshold.

The authenticating unit 606 is configured to match the biometric template of the client with the alive-being biometric template, and send the authentication result to the unit for transferring identity information 602.

As illustrated in FIG. 7, the process performed by the system according to an embodiment of the present invention includes:

701: The client-end sends an access request to the application unit;

702: The application unit invokes the unit for transferring identity information;

703: The unit for transferring identity information requests biometric certificate and attribute certificate from the client-end;

704: The client-end sends the biometric certificate and attribute certificate to the unit for transferring identity information;

705: The unit for transferring identity information invokes the extracting unit;

706: The unit for transferring identity information invokes the biometric processing unit;

707: The extracting unit verifies validity of the attribute certificate, extracts the privilege and the privilege security level, and sends the privilege security level to the biometric processing unit.

708: The biometric processing unit requests the client-end to input the corresponding biometric information of use; after acquiring the biometric information of user from the client-end, the unit for collecting biometric information sends the biometric information of user to the biometric processing unit via the corresponding software module.

709: The biometric processing unit processes the biometric information of user from the biometric information collecting unit to generate alive-being biometric template, and sends the authenticating unit the biometric template in the biometric certificate and the alive-being biometric template;

710: The authenticating unit matches the biometric template of the client with the alive-being biometric template to get a matching score, determines the result of “Accept”(Y) or “Deny”(N) according to the matching score and the threshold, and then sends the result to the unit for transferring identity information;

711: The unit for transferring identity information extracts the (access) privilege from the attribute certificate, and sends it to the application unit;

712: The application unit processes requests from the client-end according to the (access) privilege, and sends the processing result to the client-end.

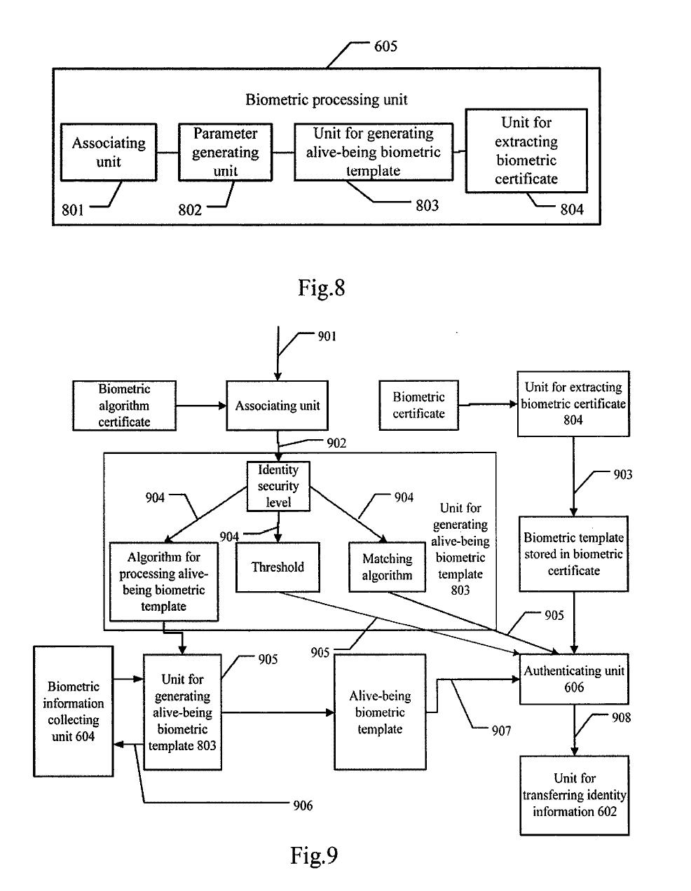

As illustrated in FIG. 8, an embodiment of the present invention' biometric processing unit 605 i.e. a device for biometric processing includes: an associating unit 801, a parameter generating unit 802, a unit for generating alive-being biometric template 803 and a unit for extracting biometric certificate 804. The associating unit 801 is configured to acquire relation of association between privilege security level and identity security level, inquire the identity security level corresponding to the privilege security level, and send the inquired identity security level to the parameter generating unit 802;

The parameter generating unit 802 is configured to generate the authentication parameters corresponding to the identity security level received, and send the authentication parameters to unit for generating alive-being biometric template 803; the unit for generating alive-being biometric template 803 is configured to generate alive-being biometric template in terms of the authentication parameters. The unit for extracting biometric certificate 804 extracts biometric template of user from the biometric certificate.

As illustrated in FIG. 9, the process performed by an embodiment of the present invention' biometric processing unit includes:

901: Acquiring privilege security level;

902: The associating unit acquires relation of association between privilege security level and identity security level, inquires the identity security level corresponding to the privilege security level, and sends the identity security level to the parameter generating unit;

903: The unit for extracting biometric certificate extracts the biometric certificate from the client-end to obtain the biometric template of user;

904: The parameter generating unit generates the authentication parameters corresponding to the identity security level received, including parameters of algorithm for processing alive-being biometric template, threshold and matching algorithm parameters;

905: The parameter generating unit sends the parameters of algorithm for processing alive-being biometric template to the unit for generating alive-being biometric template, and sends the threshold and matching algorithm parameters to the authenticating unit.

906: Requesting the client-end to input the corresponding biometric information of user; after acquiring the biometric information of user, the unit for collecting biometric information sends the biometric information of user to the unit for generating alive-being biometric template via the corresponding software module.

907: The unit for generating alive-being biometric template processes biometric information of user to generate alive-being biometric template, and sends the alive-being biometric template to the authenticating unit;

908: The authenticating unit matches the biometric template of user with the alive-being biometric template to get a matching score, determines the result of “Accept”(Y) or “Deny”(N) according to the matching score and the threshold, and sends the result to the unit for transferring identity information;

Based on the foregoing methods for authentication and what are illustrated in FIGS. 8 and 9, an embodiment of the present invention provides a template of biometric security level, and a method and system for performing biometric authentication using the template of biometric security level.

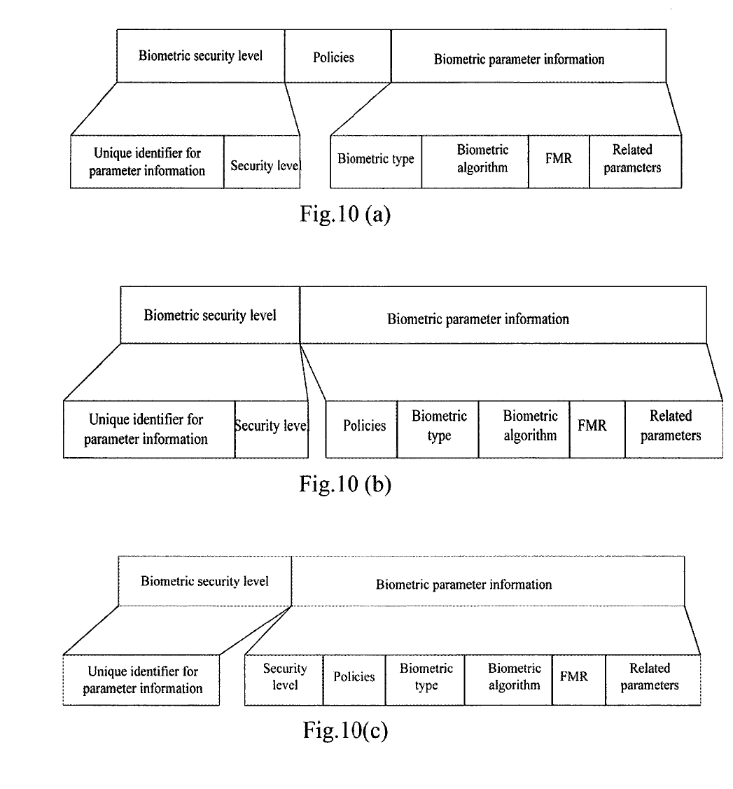

In the embodiment of the present invention, the template of biometric security level includes biometric security level, policies and biometric parameter information, whose format is illustrated in FIG. 10(a), FIG. 10(b) and FIG. 10(c). It should be noted that the format of template of biometric security level may be in other forms besides those illustrated.

As illustrated in FIG. 10(a), the template of biometric security level of an embodiment includes the following:

biometric security level, unique identifier for parameter information, security level, policies, biometric parameter information, biometric type, biometric algorithm, FMR and related parameters, wherein:

the biometric security level may include unique identifier for parameter information and security level;

the unique identifier for parameter information is configured to distinguish the parameters corresponding to the biometric security level uniquely, such as biometric parameter information and Hash value of security level and so on. This item together with security level may be provided to the client-end or a certain database. This item may be Hash value or encrypted value of parameter information.

The security level may be the mark of biometric security represented by certain policy and biometric parameter information. The basis to determine the security level includes: the policy and the value of False Match Rate corresponding to the same algorithm and the same biometric type related to the policy. The more the conditions included in the policy there are, the high the security level is, and the less FMR value is.

The policies may include: single-mode biometric authentication, “single-mode biometric authentication+alive-being checking”, multiple-mode biometric authentication, and “multiple-mode biometric authentication+alive-being checking”, etc. The policies may be extended depending on demand.

The single-mode biometric authentication may be to perform authentication using one single biometric type, for example, fingerprint, iris, venation, etc. There may be a certain device for identifying alive-being biometric features when performing alive-being biometric checking. The multiple-mode biometric authentication is to perform authentication using various alive-beings or different types of biometric features of the same alive-being.

The biometric parameter information may include: biometric type, biometric algorithm, FMR value and related parameters.

The biometric type may be the mark of biometric feature used for biometric authentication, including fingerprint, iris, face feature, and various combinations of biometric features as such fingerprint plus iris, etc.

The biometric algorithm may be the biometric processing algorithm used for performing biometric identification, including algorithm for processing alive-being biometric template and algorithm for matching biometric template, etc.

The biometric algorithm FMR may be a series of values corresponding to a certain biometric algorithm, which represents the false matching rate. The less FMR is, the higher the biometric security level is.

The related parameters may be added into the template of biometric security level on demand.

In terms of the foregoing formats, a list of biometric security level including policies, biometric parameters and security level, which illustrates identity security level, is as shown in Table 1:

TABLE 1

| Biometric | | | Biometric | | |
|---|---|---|---|---|---|
| security level | | Policies | parameter information | | |
| Hash or | Biometric | Single-mode | Bio- | Biometric | FMR i |
| encrypted | security | (A) | metric | algorithm | |
| value i | (Ai) | | type | i | |
| Hash or | Biometric | Single-mode + | Bio- | Biometric | FMR j |
| encrypted | security | alive-being | metric | algorithm | |
| value j | (Bj) | checking (B) | type | j | |
| Hash or | Biometric | Multiple-mode | Bio- | Biometric | FMR k |
| encrypted | security | (C) | metric | algorithm | |
| value k | (Ck) | | type | k | |
| Hash or | Biometric | Multiple-mode + | Bio- | Biometric | FMR l |
| encrypted | security | alive-being | metric | algorithm | |
| value l | (Dl) | checking (D) | type | i | |
| . . . | . . . | . . . | . . . | . . . | . . . |

As illustrated in Table 1, the biometric level increases from top to bottom row by row.

There is one composite item, i.e. the unique identifier for parameter information, including: “Hash or encrypted value I”, “Hash or encrypted value j”, “Hash or encrypted value k”, and “Hash or encrypted value 1”.

Security level is associated with policies and FMR. The basis to determine the security level may be to determine the value of security level according to the policy and the FMR value corresponding to the same algorithm and the same biometric type associated to a certain policy. The more conditions of policy there are, the less FMR value is, and the higher the security level is. The relation of association between the FMR value and the security level is adjusted when needed to make the value of security level reflect the value of biometric security level.

As illustrated in Table 1, the security level of policies increases in such order: single-mode<“single-mode+alive-being checking”<multiple-mode<“multiple-mode+alive-being checking”. The more conditions of policy there are, the higher the security level is.

Biometric algorithm: When the policy is the single-mode, the same biometric type may correspond to a plurality of biometric processing algorithms, for example, various algorithms for processing fingerprint. When the policy is the multiple-mod, the same combination of biometric types may correspond to combination of a plurality of algorithms. For example, the combination of “fingerprint+iris” can correspond to combination of “fingerprint algorithm 1+iris algorithm 1”, or the combination of “fingerprint algorithm 2+iris algorithm 2”.

FMR value: each algorithm or combination of algorithms may correspond to a plurality of FMR values; there may be a series of values determining the security level.

For example, when the policy is A, the biometric type is B and the biometric algorithm is C, the FMR values are 1, 2 and 3, which determine the security level. An embodiment of the present invention is illustrated in Table 2:

TABLE 2

| | Biometric | | | | | |
|---|---|---|---|---|---|---|
| | security | | Biometric | Biometric | Algorithm | Related |
| Hash value | level | Policies | type | algorithm | FMR | Parameters |
| Single-mode(A) | | | | | | |
| HashA111 | A1 | Single-mode(A) | Fingerprint | Fingerprint | FMRA111 | |
| | | | | algorithm 1 | | |
| HashA112 | A2 | Single-mode | Fingerprint | Fingerprint | FMRA112 | |
| | | | | algorithm 1 | | |
| . . . | . . . | . . . | . . . | . . . | . . . | . . . |
| HashA11i | Ai | Single-mode | Fingerprint | Fingerprint | FMRA11i | |
| | | | | algorithm 1 | | |
| HashA121 | A1 | Single-mode | Fingerprint | Fingerprint | FMRA121 | |
| | | | | algorithm 2 | | |
| HashA122 | A2 | Single-mode | Fingerprint | Fingerprint | FMRA122 | |
| | | | | algorithm 2 | | |
| . . . | . . . | . . . | . . . | . . . | . . . | . . . |
| HashA12i | Ai | Single-mode | Fingerprint | Fingerprint | FMRA12i | |
| | | | | algorithm 2 | | |
| HashA211 | A1 | Single-mode | iris | Iris | FMRA211 | |
| | | | | algorithm 1 | | |
| HashA212 | A2 | Single-mode | iris | Iris | FMRA212 | |
| | | | | algorithm 1 | | |
| . . . | . . . | . . . | . . . | . . . | . . . | . . . |
| HashA21i | Ai | Single-mode | iris | Iris | FMRA21i | |
| | | | | algorithm 1 | | |
| HashA221 | A1 | Single-mode | iris | Iris | FMRA221 | |
| | | | | algorithm 2 | | |
| HashA222 | A2 | Single-mode | iris | Iris | FMRA222 | |
| | | | | algorithm 2 | | |
| . . . | . . . | . . . | . . . | . . . | . . . | . . . |
| HashA22i | Ai | Single-mode | iris | Iris | FMRA22i | |
| | | | | algorithm 2 | | |
| . . . | . . . | . . . | . . . | . . . | . . . | . . . |
| Single-mode + | | | | | | |
| alive-being | | | | | | |
| checking (B) | | | | | | |
| HashB111 | B1 | Single-mode + | Fingerprint | Fingerprint | FMRB111 | |
| | | alive-being | | algorithm 1 | | |
| | | checking (B) | | | | |
| HashB112 | B2 | Single-mode + | Fingerprint | Fingerprint | FMRB112 | |
| | | alive-being | | algorithm 1 | | |
| | | checking | | | | |
| . . . | . . . | . . . | . . . | . . . | . . . | . . . |
| HashB11i | Bi | Single-mode + | Fingerprint | Fingerprint | FMRB11i | |
| | | alive-being | | algorithm 1 | | |
| | | checking | | | | |
| Hash121 | B1 | Single-mode + | Fingerprint | Fingerprint | FMRB121 | |
| | | alive-being | | algorithm 2 | | |
| | | checking | | | | |
| HashB122 | B2 | Single-mode + | Fingerprint | Fingerprint | FMRB122 | |
| | | alive-being | | algorithm 2 | | |
| | | checking | | | | |
| . . . | . . . | . . . | . . . | . . . | . . . | . . . |
| HashB12i | Bi | Single-mode + | Fingerprint | Fingerprint | FMRB12i | |
| | | alive-being | | algorithm 2 | | |
| | | checking | | | | |
| HashB211 | B1 | Single-mode + | iris | Iris | FMRB211 | |
| | | alive-being | | algorithm 1 | | |
| | | checking | | | | |
| HashB212 | B2 | Single-mode + | iris | Iris | FMRB212 | |
| | | alive-being | | algorithm 1 | | |
| | | checking | | | | |
| . . . | . . . | . . . | . . . | . . . | . . . | . . . |
| HashB21i | Bi | Single-mode + | iris | Iris | FMRB21i | |
| | | alive-being | | algorithm 1 | | |
| | | checking | | | | |
| HashB221 | B1 | Single-mode + | Iris | Iris | FMRB221 | |
| | | alive-being | | algorithm 2 | | |
| | | checking | | | | |
| HashB222 | B2 | Single-mode + | Iris | Iris | FMRB222 | |
| | | alive-being | | algorithm 2 | | |
| | | checking | | | | |
| . . . | . . . | . . . | . . . | . . . | . . . | . . . |
| HashB22i | Bi | Single-mode + | iris | Iris | FMRB22i | |
| | | alive-being | | algorithm 2 | | |
| | | checking | | | | |
| . . . | . . . | . . . | . . . | . . . | . . . | . . . |
| Multiple-mode | | | | | | |
| (C) | | | | | | |
| HashC111 | C1 | Multiple-mode | Fingerprint + | Fingerprint | FMRC111 | |
| | | (C) | Iris | algorithm | | |
| | | | | 1 + Iris | | |
| | | | | algorithm 1 | | |
| HashC112 | C2 | Multiple-mode | Fingerprint + | Fingerprint | FMRC112 | |
| | | | Iris | algorithm | | |
| | | | | 1 + Iris | | |
| | | | | algorithm 1 | | |
| . . . | . . . | . . . | . . . | . . . | . . . | . . . |
| HashC11i | Ci | Multiple-mode | Fingerprint + | Fingerprint | FMRC11i | |
| | | | Iris | algorithm | | |
| | | | | 1 + Iris | | |
| | | | | algorithm 1 | | |
| HashC121 | C1 | Multiple-mode | Fingerprint + | Fingerprint | FMRC121 | |
| | | | Iris | algorithm | | |
| | | | | 1 + Iris | | |
| | | | | algorithm 1 | | |
| HashC122 | C2 | Multiple-mode | Fingerprint + | Fingerprint | FMRC122 | |
| | | | Iris | algorithm | | |
| | | | | 1 + Iris | | |
| | | | | algorithm 2 | | |
| . . . | . . . | . . . | . . . | . . . | . . . | . . . |
| HashC12i | Ci | Multiple-mode | Fingerprint + | Fingerprint | FMRC12i | |
| | | | Iris | algorithm | | |
| | | | | 1 + Iris | | |
| | | | | algorithm 2 | | |
| HashC131 | C1 | Multiple-mode | Fingerprint + | Fingerprint | FMRC131 | |
| | | | Iris | algorithm | | |
| | | | | 2 + Iris | | |
| | | | | algorithm 1 | | |
| HashC132 | C2 | Multiple-mode | Fingerprint + | Fingerprint | FMRC132 | |
| | | | Iris | algorithm | | |
| | | | | 2 + Iris | | |
| | | | | algorithm 1 | | |
| . . . | . . . | . . . | . . . | . . . | . . . | . . . |
| HashC13i | Ci | Multiple-mode | Fingerprint + | Fingerprint | FMRC13i | |
| | | | Iris | algorithm | | |
| | | | | 2 + Iris | | |
| | | | | algorithm 1 | | |
| HashC211 | C1 | Multiple-mode | Fingerprint + | Fingerprint | FMRC211 | |
| | | | Face | algorithm | | |
| | | | | 1 + Face | | |
| | | | | algorithm 1 | | |
| HashC212 | C2 | Multiple-mode | Fingerprint + | Fingerprint | FMRC212 | |
| | | | Face | algorithm | | |
| | | | | 1 + Face | | |
| | | | | algorithm 1 | | |
| . . . | . . . | . . . | . . . | . . . | . . . | . . . |
| HashC21i | Ci | Multiple-mode | Fingerprint + | Fingerprint | FMRC21i | |
| | | | Face | algorithm | | |
| | | | | 1 + Face | | |
| | | | | algorithm 1 | | |
| HashC221 | C1 | Multiple-mode | Fingerprint + | Fingerprint | FMRC221 | |
| | | | Face | algorithm | | |
| | | | | 1 + Face | | |
| | | | | algorithm 2 | | |
| HashC222 | C2 | Multiple-mode | Fingerprint + | Fingerprint | FMRC222 | |
| | | | Face | algorithm | | |
| | | | | 1 + Face | | |
| | | | | algorithm 2 | | |
| . . . | . . . | . . . | . . . | . . . | . . . | . . . |
| HashC22i | Ci | Multiple-mode | Fingerprint + | Fingerprint | FMRC22i | |
| | | | Face | algorithm | | |
| | | | | 1 + Face | | |
| | | | | algorithm 2 | | |
| HashC231 | C1 | Multiple-mode | Fingerprint + | Firigerprint | FMRC231 | |
| | | | Face | algorithm | | |
| | | | | 2 + Face | | |
| | | | | algorithm 1 | | |
| HashC232 | C2 | Multiple-mode | Fingerprint + | Fingerprint | FMRC232 | |
| | | | Face | algorithm | | |
| | | | | 2 + Face | | |
| | | | | algorithm 1 | | |
| . . . | . . . | . . . | . . . | . . . | . . . | . . . |
| HashC23i | Ci | Multiple-mode | Fingerprint + | Fingerprint | FMRC23i | |
| | | | Face | algorithm | | |
| | | | | 2 + Face | | |
| | | | | algorithm 1 | | |
| . . . | . . . | . . . | . . . | . . . | . . . | . . . |

Note:
FMRA = FMRB

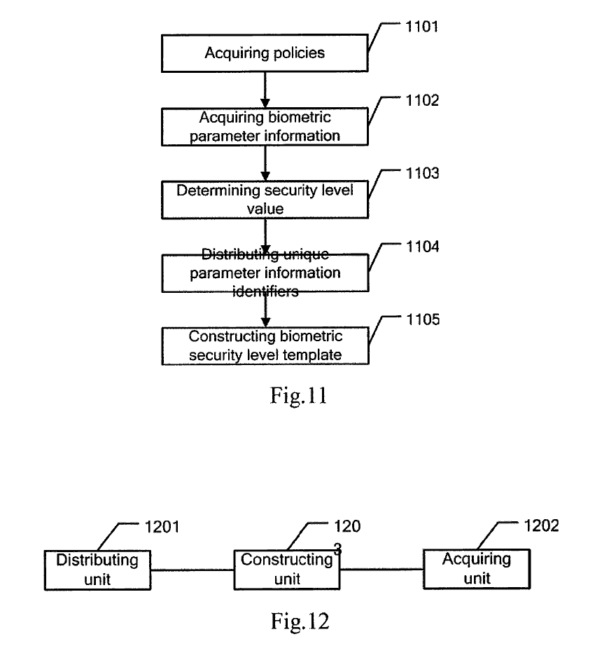

As illustrated in FIG. 11, the method for setting template of biometric security level in an embodiment of the present invention includes the following steps:

1101: Acquiring policies;

In this step, the policies including single-mode biometric authentication, “single-mode biometric authentication+alive-being checking”, multiple-mode biometric authentication, “multiple-mode biometric authentication+alive-being checking” and so on, is acquired. The policies may be extended on demand.

1102: Acquiring biometric parameter information;

In this step, the biometric parameter information includes: biometric type, and/or biometric algorithm, and/or FMR value, and/or other related parameters.

1103: Determining security level value;

In this step, the security level values are determined according to policy and the FMR value corresponding to the same algorithm and the same biometric type in accordance to the policy. The more conditions of the policy there are, the smaller the FMR value is, and the higher the security level is.

1104: Distributing unique parameter information identifiers;

In this step, the unique parameter information identifier may include biometric parameter information, Hash value or encrypted value of the security level. The unique parameter information identifier may be other identifier that may identify biometric parameter information uniquely.

1105: Constructing template of biometric security level.

As illustrated in FIG. 12, a device according to an embodiment of the present invention for setting template of biometric security level includes:

a distributing unit 1201, configured to distribute the unique parameter information identifiers for each of templates of biometric security level;

an acquiring unit 1202, configured to determine the value of security level and acquire biometric parameter information and the policy selected by user; and

a constructing unit 1203, configured to construct template of biometric security level according to the unique parameter information identifier, security level, policies and biometric parameter information.

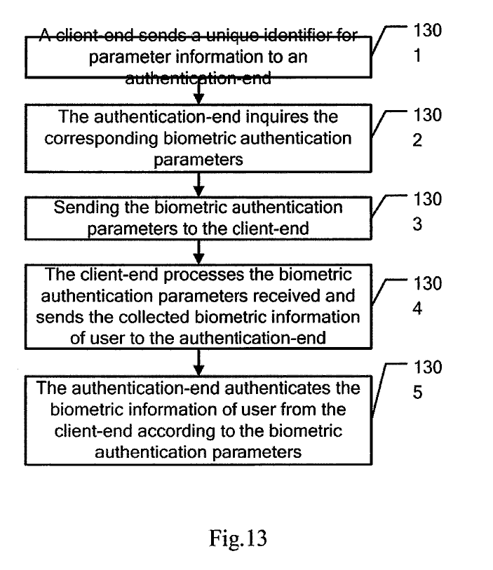

Based on the foregoing template of biometric security level, a process illustrated in FIG. 13 for biometric authentication includes the following steps:

1301: A client-end sends a unique identifier for parameter information to an authentication-end;

In this step, there are two ways as follow in which the client-end sends the unique identifier for parameter information to the authentication-end:

1. Binding Way:

A list of biometric security level is generated according to policies, biometric parameters and corresponding security levels which are obtained via evaluating various biometric algorithms by biometric authority organization. The list of biometric security level may include a plurality of biometric security templates in a certain order.

In this embodiment of the present invention, the template of biometric security level may include: biometric security level and biometric parameter information. The biometric security level may include a unique identifier for parameter information, security level and policies. Biometric parameter information may include biometric type, biometric algorithm, FMR value or other related parameters. It should be noted that the format of template of biometric security level may be in other formats.

2. Independent Way:

To use the list of biometric security level independently may be that the list of biometric security level is not stored in the biometric algorithm certificate, but in a database or a file, and when used, the list is invoked from the database or file.

If the unique identifier for parameter information is bound with the attribute certificate, the mechanism of invoking is the same as the mechanism of binding. If the unique identifier for parameter information is not bound with the attribute certificate, the unique identifier for parameter information corresponding to each user may be stored in database. When used, the corresponding unique identifier for parameter information and security level are invoked from the database or the third party, instead of being invoked from the attribute certificate.

1302: The authentication-end inquires the corresponding biometric authentication parameters.

In this step, after receiving the unique identifier for parameter information, based on the mechanism of binding, the authentication-end inquires from the list of biometric security level stored in the biometric algorithm certificate, the corresponding unique identifier for parameter information and its security level, policies, biometric type, biometric algorithm and FMR thereof.

1303: Sending the biometric authentication parameters to the client-end;

In this step, the authentication-end sends the biometric authentication parameters acquired to the client-end.

1304: The client-end processes the biometric authentication parameters received and sends the collected biometric information of user to the authentication-end.

In this step, that the client processes the biometric authentication parameters received may be an optional process, which may include:

The client-end authenticates the policy received, if the authentication is passed, consequent process may be performed and if the authentication is not passed, consequent process may be denied.

1305: The authentication-end authenticates the biometric information of user from the client-end according to the biometric authentication parameters;

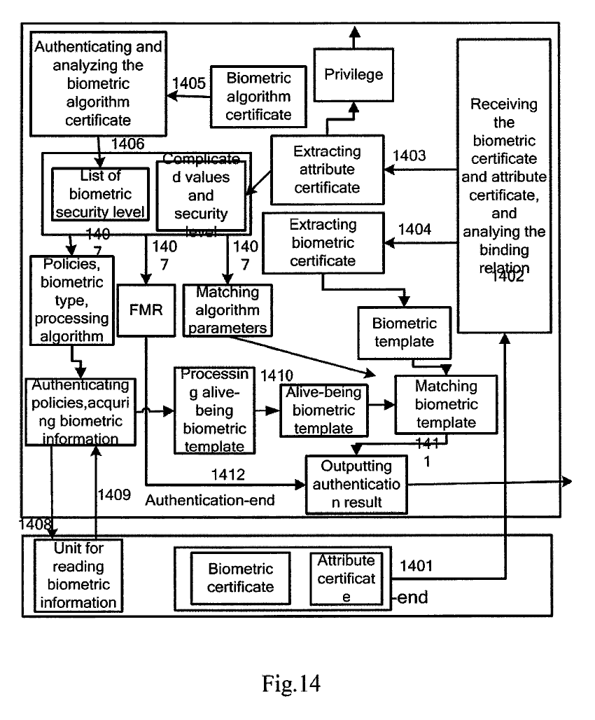

As illustrated in FIG. 14, the process for biometric authentication in an embodiment of the present invention includes:

1401: The client-end sends biometric certificate and attribute certificate to the authentication-end;

1402: The authentication-end receives the biometric certificate and attribute certificate, authenticate the validity of the biometric certificate and attribute certificate, and analyzes the binding relation between the biometric certificate and attribute certificate.

1403: Acquiring the privilege of user, unique identifier for parameter information and security level or any other identifiers that can distinguish parameters, i.e. encryption via analyzing the attribute certificate;

1404: Analyzing the biometric certificate to obtain biometric template of user;

In this step, if there is more than one biometric template of user, the corresponding biometric template of user is selected according to the biometric type;

1405: Authenticating and analyzing the biometric algorithm certificate stored on authentication-end, and obtaining the list of biometric security level;

1406˜1407: Searching corresponding biometric authentication parameters in the list of biometric security level, according to the unique identifier for parameter information and security level;

In these steps, the complicated values include: “Hash value or encrypted value i”, “Hash value or encrypted value j”, “Hash value or encrypted value k”, “Hash value or encrypted value 1’, where the Hash values and encrypted values are different to each other.

In these steps, the biometric authentication parameters include policies, biometric type, biometric algorithm and FMR value (or threshold), which may be divided into three parts:

1. the first part: policies, biometric type and processing algorithm of biometric algorithm;

2. the second part: FMR value; and

3. the third part: matching algorithm of biometric algorithm.

These three parts are respectively sent to different units for processing.

1408: The authentication-end sends policies to the client-end, and requests the client-end to authenticate the policies, if the authentication on the policies is not passed, the consequent processes may be denied.

1409: If the authentication on the policies is passed, the client-end determines whether there is biometric information of user needed for authentication stored on the client-end; if not, the user is indicated to input the corresponding biometric information of user to the client-end via input equipment. After collecting biometric information of user, the client-end sends the biometric information of user to the authentication-end. After receiving the biometric information of user, the authentication-end sends the biometric information of user to a unit for processing alive-being biometric template. The unit for processing alive-being biometric template may be set on the authentication-end, or on the client-end, or the third party. The unit for processing alive-being biometric template may equal to the foregoing unit for generating alive-being biometric template.

1410: The unit for processing alive-being biometric template processes the biometric information from the authentication-end, to obtain alive-being biometric template;

1411: The unit for matching alive-being biometric template matches the alive-being biometric template with the biometric template of user selected in step 1404 and gets matching score according to the biometric template of user selected in step 1404 and the biometric authentication parameters searched in step 1407;

1412: Determining whether the authentication is passed or not according to the FMR values, to obtain the authentication result;

In this embodiment, the list of biometric security level is stored in biometric algorithm certificate, and the unique identifier for parameter information is bound with attribute certificate. If the list of biometric security level is not stored in the biometric algorithm certificate, or the unique identifier for parameter information is not bound with the attribute certificate, the process of authentication almost remains unchanged, except that the location of the list of biometric security level or the location of the unique identifier for parameter information is changed.

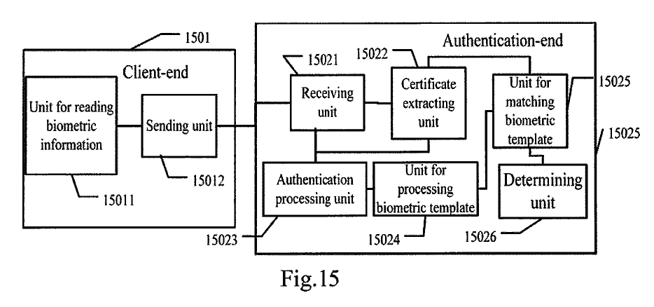

As illustrated in FIG. 15, the system for biometric authentication corresponding to the method for biometric authentication includes: a client-end 1501 and an authentication-end 1502.

The client-end 1501 is configured to send a unique identifier for parameter information to the authentication-end.

The authentication-end is configured to inquire the corresponding biometric authentication parameters by matching the unique identifier for parameter information with the identifier corresponding to the established list of biometric security level, and send the biometric authentication parameters to the client-end.

The client-end 1501 processes the received biometric authentication parameters from the authentication-end, and sends the biometric information of user to the authentication-end 1502. Processing the biometric authentication parameters by the client-end is optional. The authentication-end may send the policies within the authentication parameters to the client-end. If authentication performed on the policies by the client-end is passed, the consequent processes may be performed by the authentication-end; if authentication performed on the policies is not passed, the authentication-end may not be performed.

The authentication-end 1502 performs biometric authentication on the biometric information of user according to the biometric parameters.

The client-end 1501 includes a unit for reading biometric information 15011 and a sending unit 15012.

The unit for reading biometric information 15011 is configured to read biometric information of user provided by the user, and send the biometric information of user to the authentication-end 1502 via the sending unit 15012.

The sending unit 15012 is configured to send biometric certificate which includes biometric template of user and the attributer certificate including the unique identifier for parameter information to the authentication-end 1502.

The authentication-end 1502 includes: a receiving unit 15021, a certificate extracting unit 15022, an authentication processing unit 15023, a unit for processing biometric template 15024, a unit for matching biometric template 15025 and a determining unit 15026.

The receiving unit 15021 is configured to receive biometric certificate and attribute certificate from the sending unit 15012, send the biometric certificate and attribute certificate to the certificate extracting unit 15022; receive biometric information of user from the client-end 1501, and send the biometric information of user to the authentication processing unit 15023.

The certificate extracting unit 15022 is configured to extract biometric template of user from biometric certificate, send the biometric template of user to the unit for matching biometric template 15025, send the result extracted from the attribute certificate to the authentication processing unit 15023, and send the result extracted from the biometric algorithm certificate to the authentication processing unit 15023.

The authentication processing unit 15023 is configured to acquire biometric information of user from the receiving unit 15021 according to the result extracted form the biometric algorithm certificate, and send the biometric information of user to the unit for processing biometric template 15024.

The unit for processing biometric template 15024 is configured to generate alive-being biometric template according to the biometric information of user from the authentication processing unit 15023, and send the alive-being biometric template to the unit for matching biometric template 15025.

The unit for matching biometric template 15025 is configured to match the alive-being biometric template from the unit for processing biometric template 15024 with the biometric template of user from the certificate extracting unit 15022, to get a matching score; send the matching score to the determining unit 15026.

The determining unit 15026 is configured to determine whether the authentication is passed or not according to the matching score from the unit for matching biometric template 15025, and output the result of authentication.

The methods, devices and systems for authentication according to the embodiments of the invention have been described in details above, and the above descriptions of the embodiments are provided only to facilitate understanding of the method according to the invention. It will be appreciated for those ordinarily skilled in the art that modifications are possible in specific implementations and applications of the invention without departing from the invention. Accordingly, the specification shall not be taken in any way of limiting the scope of the invention as defined in the appended claims.

1. A method for authentication through combination of identity and privilege, comprising:
acquiring the privilege security level corresponding to a client-end;
inquiring the identity security level corresponding to the privilege security level according to an established relation of association between privilege security level and identity security level;
determining the authentication parameters for identity authentication according to the identity security level;
performing identity authentication on the client-end using the authentication parameters; and
obtaining an authentication result.

2. The method for authentication through combination of identity and privilege according to claim 1, wherein the established relation of association between privilege security level and identity security level is stored in a biometric algorithm certificate, or in a database, or in a file.

3. The method for authentication through combination of identity and privilege according to claim 1, wherein the acquiring the privilege security level corresponding to a client-end comprises:
receiving an access request from the client-end;
sending a request for biometric certificate and attribute certificate to the client-end; and
acquiring the privilege security level from the attribute certificate received from the client-end.

4. The method for authentication through combination of identity and privilege according to claim 1, wherein the authentication parameters comprise:
parameters of algorithm for processing alive-being biometric template, matching algorithm parameters and threshold.

5. The method for authentication through combination of identity and privilege according to claim 4, wherein the performing identity authentication on the client-end using the authentication parameters comprises:
acquiring biometric template of user from the biometric certificate received from the client-end;
generating alive-being biometric template according to the biometric information of user received from the client-end;
matching the alive-being biometric template with the biometric template of user to obtain a matching score;
generating the result that the authentication on the client-end is passed if the matching score is greater than or equal to the threshold; and
generating the result that the authentication on the client-end is not passed if the matching score is less than the threshold.

6. The method for authentication through combination of identity and privilege according to claim 1, further comprising:
sending the authentication result to the client-end.

7. A system for authentication through combination of identity and privilege, comprising: an extracting unit, a biometric processing unit and an authenticating unit, wherein:
the extracting unit is configured to acquire the privilege security level corresponding to a client-end, and send the privilege security level to the biometric processing unit;
the biometric processing unit is configured to inquire the identity security level corresponding to the privilege security level according to an established relation of association between privilege security level and identity security level, determine the authentication parameters for identity authentication according to the identity security level, and send the authentication parameters to the authenticating unit; and
the authenticating unit is configured to perform identity authentication on the client-end using the authentication parameters.

8. The system for authentication through combination of identity and privilege according to claim 7, further comprising: an application unit, a unit for transferring identity information, and a unit for collecting biometric information, wherein:
the application unit is configured to receive an access request from the client-end; invoke the unit for transferring identity information after receiving the access request from the client-end;
the unit for transferring identity information is configured to send a request for attribute certificate and biometric certificate to the client-end, receive the attribute certificate and biometric certificate from the client-end, send the attribute certificate to the extracting unit, send the biometric certificate to the authenticating unit, and invoke the biometric processing unit;
the unit for collecting biometric information is configured to collect biometric information of user and send the biometric information of user to the biometric processing unit.

9. The system for authentication through combination of identity and privilege according to claim 7, wherein the biometric processing unit comprises an associating unit, a parameter generating unit, a unit for generating alive-being biometric template, and a unit for extracting biometric certificate, wherein:
the associating unit is configured to acquire the relation of association between privilege security level and identity security level; inquire the identity security level corresponding to the privilege security according to the relation of association between privilege security level and identity security level; send the identity security level to the parameter generating unit;
the parameter generating unit is configured to generate authentication parameters corresponding to the identity security level received from the associating unit, and send the parameters to the unit for generating alive-being biometric template;
the unit for generating alive-being biometric template is configured to generate alive-being biometric template according to the authentication parameters from the parameter generating unit and biometric information of user; and
the unit for extracting biometric certificate is configured to extract biometric template of user from a received biometric certificate.

10. A method for biometric authentication, comprising:
acquiring a unique identifier for parameter information;
inquiring the biometric authentication parameters corresponding to the unique identifier for parameter information according to an established list of biometric security level;
receiving biometric information of user from a client-end; and
performing biometric authentication on the biometric information of user from the client-end according to the biometric authentication parameters.

11. The method for biometric authentication according to claim 10, wherein the acquiring a unique identifier for parameter information comprises:
acquiring the unique identifier for parameter information from an attribute certificate from the client-end or from a database or from a third party.

12. The method for biometric authentication according to claim 10, wherein the established list of biometric security level is stored in a database, or a file, or a biometric certificate in the authentication-end.

13. The method for biometric authentication according to claim 10, wherein the list of biometric security level comprises:
the relation of association between unique identifier for parameter information and the parameters comprising security level, policies, biometric type, biometric algorithm or false matching rate; and
the biometric authentication parameters comprising policies, biometric type, biometric algorithm, or false matching rate.

14. The method for biometric authentication according to claim 13, further comprising:
sending the policies of the biometric authentication parameters to the client-end; and
receiving biometric information of user from the client-end after the authentication performed by the client-end on the policies is passed.

15. The method for biometric authentication according to claim 13, further comprising:
receiving biometric certificate from the client-end;
verifying whether the biometric certificate is validate or not;
acquiring biometric template of user from the biometric certification if the biometric certificate is validate and there is binding relation between the biometric certificate and the attribute certification;
and wherein performing biometric authentication on the biometric information of user from the client-end according to the biometric authentication parameters comprises;
generating alive-being biometric template according to biometric information of user, the biometric type and biometric algorithm;
matching the alive-being biometric template with biometric template of user, to obtain a matching score;
evaluating the matching score according to the FMR value; and
generating authentication result.

16. A system for biometric authentication, comprising a authentication-end, wherein
the authentication-end is configured to acquire, from a client-end, a unique identifier for parameter information and biometric information of user, inquire the biometric authentication parameters corresponding to the unique identifier for parameter information according to an established list of biometric security level, and perform biometric authentication on the biometric information of user from the client-end according to the biometric authentication parameters.

17. The system for biometric authentication according to claim 16, wherein:
the authentication-end is further configured to send policies included in the authentication parameters to the client-end after acquiring the authentication parameters corresponding to the unique identifier for parameter information, and receive biometric information of user from the client-end after the authentication performed by the client-end on the policies is passed.

18. The system for biometric authentication according to claim 16, further comprising a client-end, wherein the client-end comprises:
a sending unit, configured to send the authentication-end the biometric certificate including biometric template of user and the attributer certificate including the unique identifier for parameter information; and
a unit for reading biometric information, configured to read biometric information of user provided by the user, and send the biometric information of user to the authentication-end via the sending unit.

19. The system for biometric authentication according to claim 16, wherein the authentication-end comprises: a receiving unit, a certificate extracting unit, an authentication processing unit, a unit for processing biometric template, a unit for matching biometric template and a determining unit, wherein
the receiving unit is configured to receive biometric certificate and attribute certificate from the client-end, send the biometric certificate and attribute certificate to the certificate extracting unit, receive biometric information of user from the client-end, and send the biometric information of user to the authentication processing unit;
the certificate extracting unit is configured to extract biometric template of user from biometric certificate, send the biometric template of user to the unit for matching biometric template, and send the result extracted from the biometric certificate to the authentication processing unit;
the authentication processing unit is configured to obtain the biometric information of user from the receiving unit according to the result extracted from the biometric algorithm certificate, and send the biometric information of user to the unit for processing biometric template;
the unit for processing biometric template is configured to generate alive-being biometric template according to the biometric information of user from the authentication processing unit, and send the alive-being biometric template to the unit for matching biometric template;
the unit for matching biometric template is configured to match the alive-being biometric template from the unit for processing biometric template with the biometric template of user to obtain a matching score, and send the matching score to the determining unit; and
the determining unit is configured to determine whether the authentication is passed or not according to the matching score from the unit for matching biometric template, and output the result of authentication.
